(19) United States
(12) Patent Application Publication
(10) Pub. No.: US 2012/0014594 A1
(43) Pub. Date: Jan. 19, 2012

(54) METHOD FOR TONE MAPPING AN IMAGE

(76) Inventors: Niranjan Damera-Venkata, Mountain View, CA (US); Nelson Liang An Chang, San Jose, CA (US)

(21) Appl. No.: 13/258,563

(22) PCT Filed: Jul. 30, 2009
(86) PCT No.: PCT/US09/52226

§ 371 Date: Sep. 22, 2011

(51) Int. Cl. G06K 9/00

(52) U.S. Cl. 382/165

(57) ABSTRACT

A method for tone mapping a digital image comprised of a plurality of high bit depth intensity values in linear space is disclosed. First, a plurality of liner intensity values are mapped from the linear space to a non-linear space (402). Then a left and a right boundary interval value are determined in the linear space for each of the plurality of high bit depth intensity value (404). A dither pattern is then overlaid onto the plurality of high bit depth intensity values in linear space (406). For each one of the plurality of high bit depth intensity values in linear space, one of the boundary interval values is selected, based on the current high bit depth intensity value, the left and right boundary interval values for the current pixel, and the dither pattern value overlaid onto the current pixel (408). Each of the selected boundary interval values are mapped into a lower bit depth non-linear space (410). And then the mapped selected boundary interval values are stored onto a computer readable medium.

### BACKGROUND

Many capture device, for example scanners or digital cameras, capture images as a two dimensional array of pixels. Each pixel will have associated intensity values in a predefined color space, for example red, green and blue. The intensity values may be captured using a high bit depth for each color, for example 12 or 16 bits deep. The captured intensity values are typically linearly spaced. When saved as a final image, or displayed on a display screen, the intensity values of each color may be converted to a lower bit depth with a non-linear spacing, for example 8 bits per color. A final image with 8 bits per color (with three colors) may be represented as a 24 bit color image. Mapping the linear high bit depth image (12 or 16 bits per color) into the lower non-linear bit depth image (8 bits per color) is typically done using a gamma correction tone map.

Multi-projector systems often require high-bit depth to prevent contouring in the blend areas (the blends must vary smoothly). This becomes a much more significant issue when correcting black offsets digitally since a discrete digital jump from 0 to 1 does not allow a representation of continuous values in that range. Also, in a display system the “blends” or subframe values are often computed in linear space with high precision (16-bit) and then gamma corrected to 8 non-linear bits.

As shown above, there are many reasons a high bit depth linear image is converted or mapped into a lower bit depth non-linear image. During the mapping process, contouring of the dark areas of the image may occur. Contouring is typically defined as a visual step between two colors or shades.

### BRIEF DESCRIPTION OF THE DRAWINGS

FIG. 1 is a two dimensional array of intensity values representing a small part of an image, in an example embodiment of the invention.

FIG. 2 is a table showing the mapping of the intensity values of a linear 4 bit image into the intensity values of a non-linear 2 bit image with a gamma of 2.2.

FIG. 3 shows the image from FIG. 1 after having been mapped into a 2 bit (4 level) space using a 2.2 gamma mapping.

FIG. 4 is a flow chart showing a method for combining gamma correction with dithering in an example embodiment of the invention.

FIG. 5a is a table showing the intensity values of the high bit depth image in an example embodiment of the invention.

FIG. 5b is a table showing the intensity values of the lower bit depth image in non-linear space and in linear space, in an example embodiment of the invention.

FIG. 6 is a dither pattern in an example embodiment of the invention.

FIG. 7 is a small image, in an example embodiment of the invention.

FIG. 8 is a table that lists the results for overlaying the dither pattern in FIG. 6 onto the small image of FIG. 7, in an example embodiment of the invention.

FIG. 9 is a final image in an example embodiment of the invention.

FIG. 10 is a block diagram of a computer system 1000 in an example embodiment of the invention.

### DETAILED DESCRIPTION

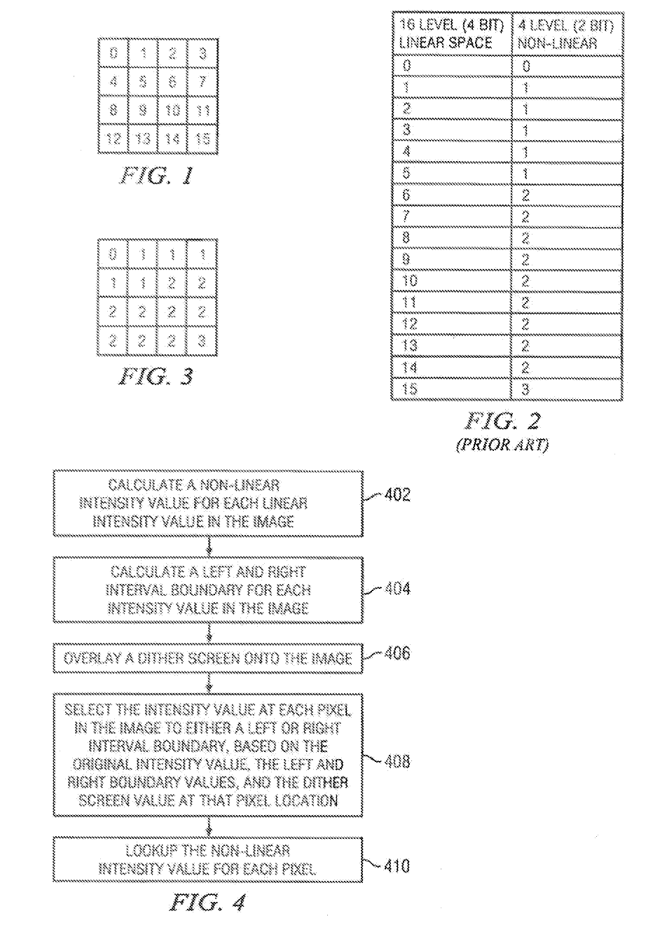

FIGS. 1-10 and the following description depict specific examples to teach those skilled in the art how to make and use the best mode of the invention. For the purpose of teaching inventive principles, some conventional aspects have been simplified or omitted. Those skilled in the art will appreciate variations from these examples that fall within the scope of the invention. Those skilled in the art will appreciate that the features described below can be combined in various ways to form multiple variations of the invention. As a result, the invention is not limited to the specific examples described below, but only by the claims and their equivalents.

Mapping an image from a high bit depth linear image into a lower bit depth non-linear image can be done over many different bit depth levels. For example mappings may be done from 16 bits (65,536 levels) to 8 bits (256 levels), from 12 bit to 8 bits, from 8 bits to 4 bits, from 4 bits into 2 bits, or the like. When using gamma correction for the mapping, each intensity level in the high bit depth image is first normalized to between 0 and 1. In one embodiment, each color channel is processed independently. Normalization is done by dividing the original intensity value by the largest possible intensity value for the current bit depth. For example if the original intensity value was 50 for an 8 bit image (and the intensity range was from 0-255), the normalized value would be 50/255 or 0.196078. When using gamma compression as the mapping function, the mapped non-linear intensity value (normalized between 0 and 1) is given by equation 1.

Normalized Non-linear Value=(NormalizedValue)̂(1/gamma) Equation 1

In equation 1, the normalized Non-linear intensity value is given by raising the normalized intensity value to one over the gamma value. For a gamma of 2.2, the normalized intensity value would be raised to the power of 1/2.2 or 0.4545. The original intensity value of 50 would yield a normalized mapped value of 0.4812 (0.196078̂0.4545=0.476845). The final intensity value in non-linear space is generated by multiplying the normalized mapped value by the highest intensity level in the mapped non-linear space. For example if the 8 bit value was being mapped into a 4 bit or 16 level value (with an intensity range from 0-15), the final mapped intensity value would be given by multiplying the normalized mapped value by 15, or 0.476845 *15=7.

FIG. 1 is a two dimensional array of intensity values representing a small part of an image, in an example embodiment of the invention. The image in FIG. 1 is a 4 bit image with intensity values ranging from 0-15. FIG. 2 is a table showing the mapping of the intensity values of a linear 4 bit image into the intensity values of a non-linear 2 bit image with a gamma of 2.2. FIG. 3 shows the image from FIG. 1 after having been mapped into a 2 bit (4 level) space using a 2.2 gamma mapping. FIG. 3 may have visible banding between the 3 different levels.

In one example embodiment of the invention, a dithering step is combined with the mapping step to produce an image that may show less contouring. FIG. 4 is a flow chart showing a method for combining gamma correction with dithering in an example embodiment of the invention. Using the method shown in FIG. 4, a high bit depth linear image is represented using a smaller number of non-linear levels where the smaller number of non-linear levels are spatially modulated across the final image.

At step 402 in FIG. 4, each intensity value in the high bit depth linear image is mapped to an intensity value in the non-linear space. In one example embodiment of the invention, the mapping is done using gamma correction. In other example embodiments of the invention, other mapping algorithms may be used. At step 404 a left and right interval boundary is calculated for each of the intensity values in non-linear space. Once the left and right interval boundaries are calculated, they are mapped into linear space.

At step 406 a dither pattern is overlaid onto the pixels of the original image in linear space. At step 408 the intensity value at each pixel is snapped to one of the two closest left and right interval boundaries in linear space, based on the original linear intensity value, the left and right interval boundary values (in linear space), and the value of the dither screen at that pixel location. At step 410 the non-linear gamma corrected intensity value for the pixel location is determined.

The following example will help illustrate one example embodiment of the invention. In this example a 4 bit, or 16 level, linear image will be converted into a 2 bit, or 4 level, non-linear image. The 4 bit image has possible intensity values ranging from 0-15. We will use the image shown in FIG. 7 for this example. The first step is to map each intensity value in the high bit depth linear image to an intensity value in the non-linear space. Equation 1 is used for mapping from a linear image to a non-linear image when the mapping is done using a gamma correction function.

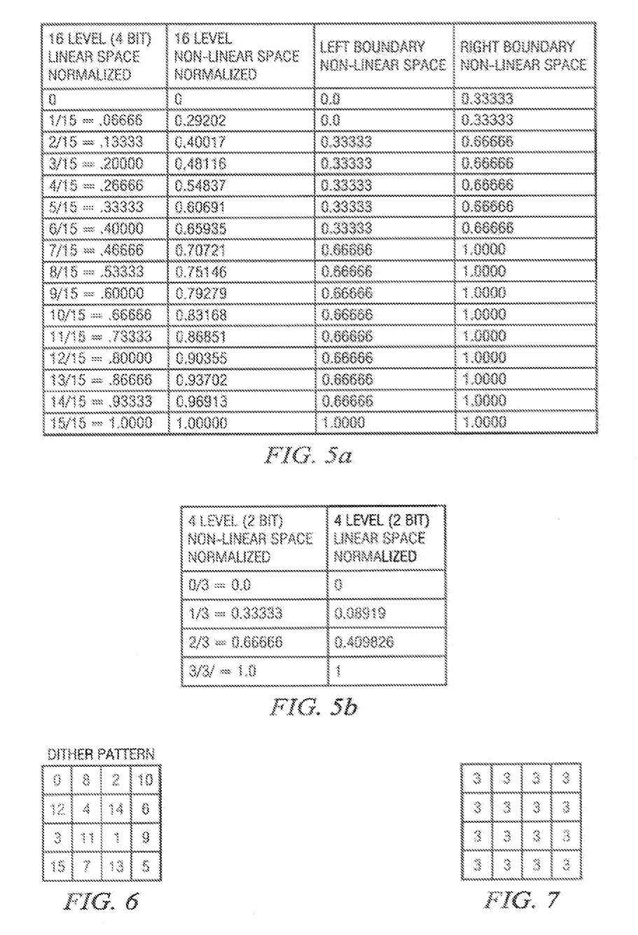

For this example a 2.2 gamma compression will be used. FIG. 5a is a table showing the intensity values of the high bit depth image in an example embodiment of the invention. The first column in FIG. 5a lists the normalized intensity values in 4 bit linear space. The second column in FIG. 5a lists the normalized intensity values in non-linear space. Each intensity value in column 2 was generated using equation 1 with a 2.2 gamma correction. For example the gamma corrected value for intensity value 2 (in non-linear space) is generated by first normalizing the 4 bit value, and then raising that normalized value to the power of 1/2.2 resulting in a value of 0.40017 ((0.13333)̂(1/2.2)=0.40017).

The next step is to generate the left and right boundary intervals for each high bit depth intensity value. The left and right boundary intervals represent the two closest lower bit depth non-linear intensity values to the current non-linear intensity value. Equations 2 and 3 are used to calculate the left and right boundary intervals respectively.

Left=((integerValue(IntensityVal*MaxIV)/MaxIV) Equation 2

Right=(((integerValue(IntensityVal*MaxIV)−=1)/MaxIV) Equation 3

Where IntensityVal is the normalized high bit depth intensity value in non-liner space, MaxIV is the maximum low bit depth intensity value, and intergerValue is a function that truncates any fractional value (i.e. it converts a floating point value into an integer value). To understand these equations, each part will be discussed.

The first step in equation 1 [integerValue(IntensityVal*MaxIV)] takes the normalized high bit depth intensity value and multiplies it by the maximum quantized low bit depth intensity value. The result is converted from a floating point value into an integer. This converts the normalized high bit depth intensity value into a lower bit depth intensity value. The second step in equation 1 normalizes the lower bit depth value to between zero and one by dividing by the maximum low bit depth intensity value. The calculation for the left boundary interval value in non-linear space for the 4 bit intensity value of 6 is shown below.

Left=((integerValue(0.65935*3))/3)

Left=((integerValue(1.97805))/3)

Left=(1/3)

Left=0.33333

The next step is to translate the left and right non-linear values into linear space. When the mapping between linear and non-linear space has been done using gamma correction, the linear values are calculated by raising the non-linear values to the power of gamma. FIG. 5b is a table showing the intensity values of the lower bit depth image in non-linear space and in linear space, in an example embodiment of the invention. The first column in FIG. 5b lists the intensity values of the lower bit depth image in non-linear space. The second column in table 5b lists the intensity values of the lower bit depth image in linear space.

In the next step, a dither pattern is overlaid onto the pixels of the original image in linear space. For this application a dither pattern may be a matrix of threshold intensity values, a single threshold intensity value with a pattern for propagating error to other pixels, a single threshold with a pattern of noise addition, or the like. For this example the dither pattern is shown in FIG. 6. Any type of dither pattern may be used, including error diffusion or random noise injection. The size of the dither pattern may also be varied. The dither pattern shown in FIG. 6 is a 4×4 Bayer dither pattern. Before the dither pattern is overlaid onto the intensity values in the original image, the intensity values in the dither pattern are normalized to a value between 0 and 1.

In the next step the intensity value at each pixel is snapped to one of the two closest left and right interval boundaries in linear space, based on the original linear intensity value, the left and right interval boundary values in linear space, and the value of the dither screen at that pixel location. The correct left or right interval boundary is selected using equations 4 and 5.

CompVal=IntensityN−left>DitherN*(right−left) Equation 4

SelectedVal=CompVal*right+(1−CompVal)*left Equation 5

Where IntensityN is the original high bit depth linear intensity value for the current pixel normalized to between 0 and 1, left and right are the left and right boundary intervals in linear space for the current intensity value, and Dither is the normalized dither value for the current pixel. CompVal is set to zero when the expression is false and CompVal is set to one when the expression is true. SelectedVal will equal the right value when CompVal is one, and will equal the left value when CompVal is a zero.

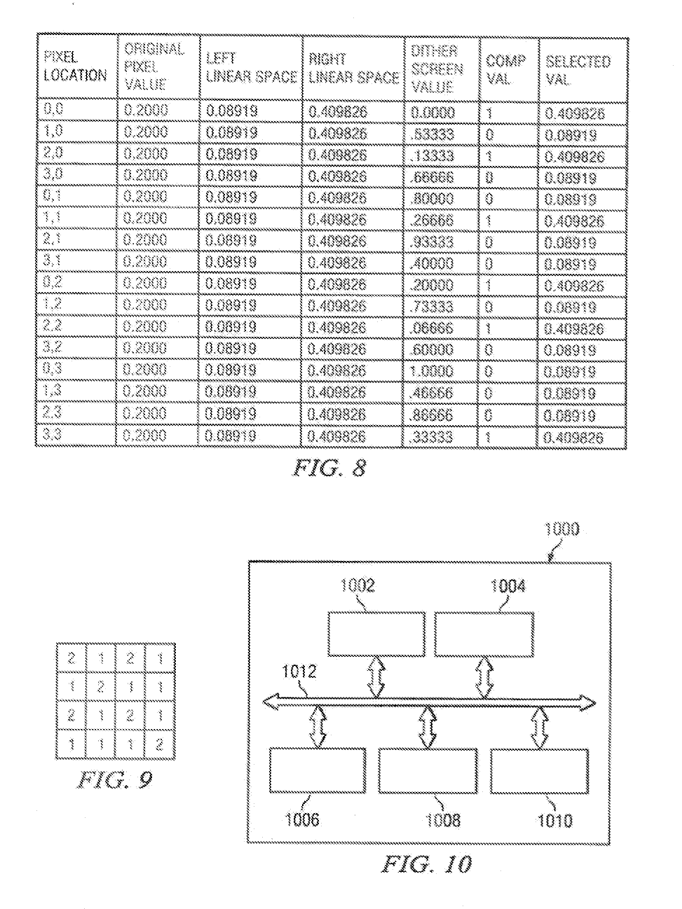

FIG. 7 is a small section of an image, in an example embodiment of the invention. FIG. 8 is a table that lists the results for overlaying the dither pattern in FIG. 6 onto the small image of FIG. 7, in an example embodiment of the invention. The first column in FIG. 8 lists the pixel location in the image. The second column lists the normalized intensity value of the image for each pixel location. The third and fourth columns list the left and right boundary intervals in linear space for each pixel location, respectively. The fifth column lists the normalized dither pattern value for each pixel location. The sixth column lists the calculated CompVal for each pixel location. The last column lists the SelectedVal for each pixel location.

Equations 4 and 5 are used to calculate the last two columns in FIG. 8. The calculation for the CompVal and the SelectedVal for pixel 2, 0 is shown below.

CompVal=IntensityN−left>DitherN*(right−left)

CompVal=0.20000−0.08919>0.13333*(0.409826−0.08919)

CompVal=0.11081>0.13333*0.32064

CompVal=0.11081>0.04275 is true therefore CompVal is set to one

SelectedVal=CompVal*right+(1−CompVal)*left

SelectedVal=1*0.409826+(1−1)*0.08919

SelectedVal=0.409826

The last step is to map the selected value from the linear space to the non-linear space. This can be done using a lookup table. The lookup table in FIG. 5b is used for this example. FIG. 9 is the final image from the example above.

Once the selected intensity values have been mapped into the lower bit depth non-linear space, the image can be saved or stored onto a computer readable medium. A computer readable medium can comprise the following: random access memory, read only memory, hard drives, tapes, optical disk drives, non-volatile ram, video ram, and the like. The image can be used in many ways, for example displayed on one or more displays, transferred to other storage devices, or the like.

The method describe above can be executed on a computer system. FIG. 10 is a block diagram of a computer system 1000 in an example embodiment of the invention. Computer system has a processor 1002, a memory device 1004, a storage device 1006, a display 1008, and an I/O device 1010. The processor 1002, memory device 1004, storage device 1006, display device 1008 and I/O device 1010 are coupled together with bus 1012. Processor 1002 is configured to execute computer instruction that implement the method describe above.

1. A method for tone mapping a high bit depth linear digital image into a lower bit depth non-linear digital image wherein the digital image is comprised of a plurality of high bit depth intensity values in linear space stored on a computer readable medium, comprising:
mapping the plurality of high bit depth intensity values from the linear space to a non-linear space;
determining a left and a right boundary interval value in the linear space for each of the plurality of high bit depth intensity values;
overlaying a dither pattern onto the plurality of high bit depth intensity values in linear space wherein the dither pattern comprises a plurality of dither pattern values;
selecting, for each one of the plurality of high bit depth intensity values in linear space, one of the boundary interval values in the linear space, based on the one high bit depth intensity value, the left and right boundary interval values for the one high bit depth intensity value, and the dither pattern value overlaid onto the one high bit depth intensity value;
mapping each of the selected boundary interval values into the lower bit depth non-linear space;
storing the mapped selected boundary interval values onto a computer readable medium.

2. The method for tone mapping an image of claim 1, wherein mapping each of the selected boundary interval values into the lower bit depth non-linear space is done using a gamma function.

3. The method for tone mapping an image of claim 1, wherein the left and right boundary interval values represent a closest two lower bit depth non-linear intensity values.

4. The method for tone mapping an image of claim 3, wherein the left boundary interval values in the non-linear space equal ((integerValue(IntensityVal*MaxIV)/MaxIV), wherein IntensityVal is the high bit depth intensity value in non-liner space, MaxIV is a maximum low bit depth intensity value in non-linear space, and intergerValue is a function that truncates any fractional value; and
Wherein the right boundary interval values in the non-linear space equal
(((integerValue(IntensityVal*MaxIV)+1)/MaxIV).

5. The method for tone mapping an image of claim 1, wherein selecting one of the boundary interval values in the linear space comprises:
selecting the left boundary interval value of the one high bit depth intensity value when IntensityN−left>DitherN*(right−left) is false, wherein IntensityN is the one high bit depth intensity value in the linear space, left and right are the left and right boundary intervals in the linear space for the one high bit depth intensity value, and Dither is the normalized dither value in the linear space overlaid onto the one high bit depth intensity value;
selecting the right boundary interval value of the one high bit depth intensity value when IntensityN−left>DitherN*(right−left) is true.

6. The method for tone mapping an image of claim 1, wherein the high bit depth image has a bit depth selected from the following bit depths: 24 bits deep, 16 bits deep, and 12 bits deep.

7. The method for tone mapping an image in claim 1, wherein the lower bit depth image has a bit depth selected from the following bit depths: 12 bits deep, 8 bits deep, 4 bits deep and 2 bits deep.

8. The method for tone mapping an image of claim 1, further comprising;
displaying, on at least one display, the final image.

9. An apparatus, comprising:
a processor configured to execute computer instructions;
a memory coupled to the processor and configure to store computer readable information;
a plurality of high bit depth linear intensity values that represent an image stored in the memory;
the processor configured to map the plurality of high bit depth intensity values from the linear space to a non-linear space;
the processor configured to determine a left and a right boundary interval value in the linear space for each of the plurality of high bit depth intensity value;
the processor configure to overlay a dither pattern onto the plurality of high bit depth intensity values in linear space wherein the dither pattern comprises a plurality of dither pattern values;
the processor configure to select, for each one of the plurality of high bit depth intensity values in linear space, one of the boundary interval values in the linear space, based on the one high bit depth intensity value in the linear space, the left and right boundary interval values in the linear space for the one high bit depth intensity value, and the dither pattern value in the linear space overlaid onto the one high bit depth intensity value;
the processor configured to map each of the selected boundary interval values into a lower bit depth non-linear space;
the processor configured to store the mapped selected boundary interval values into the memory.

10. The apparatus of claim 9, wherein each of the selected boundary interval values are mapped from the linear space to a non-linear space using a gamma function.

11. The apparatus of claims 9, wherein the left boundary interval values in the non-linear space equal ((integerValue(IntensityVal*MaxIV)/MaxIV), wherein IntensityVal is the high bit depth intensity value in non-liner space, MaxIV is a maximum low bit depth intensity value in non-linear space, and intergerValue is a function that truncates any fractional value; and
wherein the right boundary interval values equal
(((integerValue(IntensityVal*MaxIV)+1)/MaxIV).

12. The apparatus of claims 9, wherein selecting one of the boundary interval values in the linear space comprises:
selecting the left boundary interval value of the one high bit depth intensity value when IntensityN−left>DitherN*(right−left) is false, wherein IntensityN is the one high bit depth intensity value in the linear space, left and right are the left and right boundary intervals in the linear space for the one high bit depth intensity value, and Dither is the normalized dither value in the linear space overlaid onto the one high bit depth intensity value;
selecting the right boundary interval value of the one high bit depth intensity value when IntensityN−left>DitherN*(right−left) is true.

13. The apparatus of claims 9, wherein the high bit depth image has a bit depth selected from the following bit depths: 24 bits deep, 16 bits deep, and 12 bits deep.

14. The apparatus of claims 9, wherein the lower bit depth image has a bit depth selected from the following bit depths: 12 bits deep, 8 bits deep, 4 bits deep and 2 bits deep.

15. The apparatus of claims 9, further comprising:
at least one display, wherein the processor displays the final image on the at least one display.
